(19) United States
(12) Patent Application Publication
(10) Pub. No.: US 2010/0080900 A1
(43) Pub. Date: Apr. 1, 2010

(54) PROCESS FOR PRODUCING COMPOSITE ELEMENTS BASED ON FOAMS BASED ON ISOCYANATE

(75) Inventors: Martin Geraedts, Quernheim (DE); Oliver Clamor, Stemwede-Dielingen (DE); Gunnar Kampf, Stemwede-Haldem (DE); Roland Fabisiak, Brockum (DE); Rainer Hensiek, Melle (DE); Marco Balbo-block, Osnabrueck (DE); Gianpaolo Tomasi, Diepholz (DE); Werner Illichmann, Lemfoerde (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/527,715

(22) PCT Filed: Feb. 21, 2008
(86) PCT No.: PCT/EP08/52098

§ 371 Date: Aug. 19, 2009

(30) Foreign Application Priority Data
Feb. 28, 2007 (EP) 07103221.3

(51) Int. Cl. B05D 1/30; B05D 5/00; B05D 3/12; B05C 5/00

(52) U.S. Cl. 427/240; 427/420; 427/256; 118/300

(57) ABSTRACT

The invention relates to a process for producing composite bodies comprising at least one covering layer a) and a rigid foam based on isocyanate b), in which the covering layer a) is moved continuously and the starting material for the rigid foam based on isocyanate b) is applied to the covering layer, wherein the application of the liquid starting material for the rigid foam based on isocyanate b) is effected by means of a fixed tube which is provided with orifices and is arranged parallel to the covering layer a) and at right angles to the direction of movement of the covering layer a).

The invention relates to a process for producing composite elements from at least one covering layer and a foam-forming reaction mixture which is applied by means of a fixed casting bar to the lower covering layer.

The production of composite elements comprising, in particular, metallic covering layers and a core of foams based on isocyanate, usually polyurethane (PUR) or polyisocyanurate (PIR) foams, frequently also referred to as sandwich elements, on continuously operating double belt units is at present carried out on a large scale. Apart from sandwich elements for insulation of refrigerated rooms, these elements are becoming increasingly important for the construction of façades of a wide variety of buildings. As covering layers, use is made of coated steel sheets and also stainless steel, copper or aluminum sheets. Particularly in the case of façade elements, the surface structure of the foam boundary to the covering layer plays a critical role. For a wide variety of reasons, undesirable air inclusions between the lower covering layer and the foam based on isocyanates, known as voids, often occur in the production of the sandwich elements. These air inclusions between the metal sheet and foam can lead, particularly in the case of large temperature changes and dark colors of the covering layer when the elements are used as façade elements, lead to bumps in the metal sheet and spoil the appearance of the façade.

Furthermore, the adhesion between insulating foam and lower covering layer is reduced. It is often the case that the lower covering layer in sandwich elements displays the poorest adhesion, determined in a tensile test. Furthermore, the metal sheet on the underside forms the outside of the façade in the usual constructions produced by means of sandwich elements, so that it is exposed to extreme conditions such as temperature and suction and is therefore subject to greater stress than the upper side of the sandwich element, which can lead to detachment of the foam from the metal sheet and thus likewise to bumps.

It is therefore necessary to find a process which lastingly minimizes or completely avoids void formation at the surface of the rigid foams based on isocyanate and also works in the case of adverse external conditions in the production process. The process should be able to be used continuously or discontinuously. A discontinuous procedure can, for example, come into question during start-up of the double belt and in the case of composite elements produced by means of discontinuous pressing. The process is carried out continuously when double belt units are used.

In the case of the double belt process according to the prior art, the reaction mixture is produced by machine using the high- or low-pressure technique and is applied by means of oscillating casting bars to the lower covering layer. Here, the casting bar is aligned in the direction of movement of the belt and oscillates across the width of the element. A disadvantage of this method of application is that void formation on the upper side cannot be avoided completely, since air bubbles are always formed in the reaction mixture due to the manner of application. This disadvantage becomes greater the shorter the time between application of the reaction mixture and commencement of the foaming reaction. The velocity of the continuously operating double belt is limited by the maximum possible oscillation speed of the mixing head. An additional disadvantage is that as oscillation increases, more reaction mixture is applied in the edge region and less in the middle region of the covering layer.

In an alternative rapid process, the reaction mixture is applied by multifinger application to the lower covering layer, and in this case too, air bubbles are included in the reaction mixture and only surfaces suffering from voids can likewise be produced. In addition, in this method of application, the reaction mixture has to spread sideways over relatively large regions so that relatively large void zones are formed on the lower and upper covering layer, especially in the outermost regions before the individual streams of the multifinger application flow into one another. Furthermore, there is frequently a furrow or at least a foam defect visible in the region in which the streams of the multifinger application flow into one another.

To alleviate this defect, DE 197 41 523 proposes blowing air onto the still flowable foam mixture after application of the liquid reaction mixture for the rigid foam to the covering layer. This is said to smooth the surface of the reaction mixture and reduce the inclusion of air bubbles. A disadvantage of this procedure is, firstly, that the blowing-on of air represents an additional process step. Secondly, the stream of air can lead to banking-up of the reaction mixture, which likewise causes an irregular surface.

It was an object of the present invention to discover a process for applying a reaction mixture for a rigid foam based on isocyanate, in particular a PUR or PIR system, to a horizontal metal sheet or another flexible or rigid covering layer which is transported continuously in a horizontal direction as is customary for production of sandwich elements using a continuously operating double belt. The process should give a surface structure of the foam on the lower covering layer which is improved compared to the prior art and, in particular, lead to avoidance of voids. Furthermore, the process should lead to improved adhesion between covering layer and rigid foam. In particular, the surface of the applied foam should be uniform. The process should, in particular, be suitable for fast-creaming systems and the abovementioned disadvantages of multifinger application and of oscillating casting bar application should be avoided.

This object has surprisingly been able to be achieved by the reaction mixture being applied to the lower covering layer by means of a fixed tube which is provided with orifices and is arranged parallel to the covering layer a) and at right angles to the direction of movement of the covering layer a), hereinafter also referred to as casting bar.

The invention accordingly provides a process for producing composite bodies comprising at least one covering layer a) and a rigid foam based on isocyanate b), in which the covering layer a) is moved continuously and the starting material for the rigid foam based on isocyanate b) is applied to the covering layer, wherein the application of the liquid starting material for the rigid foam based on isocyanate b) is effected by means of a fixed tube which is provided with orifices and is arranged parallel to the covering layer a) and at right angles to the direction of movement of the covering layer a). The terms holes and orifices can be used synonymously in the following.

The invention further provides an apparatus for applying reaction mixtures to a continuously transported covering layer, wherein the apparatus is a fixed tube which is provided with orifices and is arranged parallel to the covering layer a) and at right angles to the direction of movement of the covering layer a).

The casting bar according to the invention has, as stated, a tube-like shape and has holes on the underside distributed over the entire length of the casting bar and the inlet for the reaction mixture is located either at the end of the casting bar or preferably in the middle.

The casting bar has a length which corresponds essentially to the width of the belt unit and has a tube diameter of from 0.2 to 5 cm, preferably from 0.3 to 3 cm. The number of holes along the casting bar is, depending on the length of the casting bar, from 20 to 200, preferably from 40 to 100. The hole diameters are in the range from 0.5 to 5 mm, preferably from 1.0 mm to 4 mm, and the hole spacings are from 5 to 60 mm, preferably from 10 to 30 mm.

The casting bar is usually arranged at a height of from 10 to 30 cm, preferably from 15 to 25 cm, from the lower covering layer.

In a particular embodiment of the invention, the diameter of the tube decreases from the middle to the ends of the tube. Furthermore, the diameter of the outlet holes and/or the spacing of the holes can be reduced from the middle to the ends of the casting bar. These measures, which can be implemented either alone or in combination with one another, are intended to keep the velocity of the reaction mixture in the tube or on exiting the holes constant.

The length of the tube can be equal to the width of the covering layer a). The length of the tube is preferably smaller than the width of the covering layer a) in order to ensure that the reaction mixture is not partly applied next to the covering layer. The casting bar is arranged centrally above the covering layer a). The casting bar preferably covers at least 70% of the width of the covering layer a). In the case of a width of the covering layer of 1.20 m, as is customary in sandwich elements, a width of 25 cm on each side would in this case not be covered by the casting bar. The casting bar preferably covers at least 80% of the width of the covering layer a), particularly preferably at least 90%.

The process of the invention is suitable for all rigid foams based on isocyanate, e.g. polyurethane (PU) foams, and foams having urethane and isocyanurate groups, hereinafter also referred to as PUR/PIR foams or simply as PIR foams. For many applications of the composite bodies produced by the process of the invention, a PIR foam is preferably used as rigid foam based on isocyanate.

The process of the invention is particularly useful for foams having a short cream time of the system. The cream time of the systems used for the process of the invention is preferably below 15 s, more preferably below 12 s, particularly preferably below 10 s and in particular below 8 s, at a fiber time of the system of 45 s. For the purposes of the present invention, the cream time is the time between mixing of the polyol component and the isocyanate component and the commencement of the urethane reaction. The fiber time is the time from mixing of the starting components of the foams to the point in time at which the reaction product is no longer flowable. The fiber time is adapted according to the element thickness produced and the double belt speed.

In a particular embodiment of the process of the invention, a bonding agent c) can be applied between the covering layer a) and the rigid foam based on isocyanate b). As bonding agents c), it is possible to use the bonding agents known from the prior art. In particular, polyurethanes are used, in which case it is possible to use either reactive one-component systems or reactive two-component systems.

The bonding agent c) is applied before, in the direction of movement of the covering layer a), the tube provided with orifices. The distance between the application of the bonding agent c) and the application of the starting components for the rigid foam based on isocyanate b) should be selected so that the bonding agent c) has not yet completely reacted on application of the starting components for the rigid foam based on isocyanate b).

The bonding agent c) can be applied to the covering layer by known methods, for example by spraying. The bonding agent c) is preferably applied to the covering layer by means of a rotating flat disk which is arranged horizontally or at a slight angle to the horizontal of up to 15°, preferably parallel to the covering layer a). The disk can in the simplest case be circular or elliptical and flat. The disk preferably has a serrated edge or has a star shape, with the points of the star being able to be curved upward.

The disk can be completely flat or be rounded or beveled upward at the edge. Preference is given to using a disk which is rounded or beveled upward at the edges. Holes are provided in the bevel in order to effect discharge of the bonding agent c). The diameter and number of the holes are matched to one another so that very uniform finely divided application of the bonding agent c) to the underlying covering layer is possible, all of the material applied to the disk can be discharged and the maintenance requirement for the disk is minimal.

In one embodiment, the disk has a cascade-like configuration. Here, the cascades rise from the axis of rotation outward. Holes can be provided in the disk at the transitions from one cascade to the next so that part of the bonding agent can be discharged onto the lower covering layer at these cascade transitions. Such a disk having a cascade-like configuration ensures particularly uniform application of the bonding agent to the covering layer located underneath. The application of the bonding agent to the disk is effected as close as possible to the axis of rotation. It has surprisingly been found that the bonding agent is distributed particularly uniformly over the lower covering layer when the point of application of the bonding agent is parallel to the production direction exactly before or after the axis of rotation.

The disk has, depending on the width of the covering layer, a diameter in the range from 0.05 to 0.3 m, preferably from 0.1 to 0.25 m, particularly preferably from 0.12 to 0.22 m, based on the long side. It is installed at a height of from 0.02 to 0.2 m, preferably from 0.03 to 0.18 m, particularly preferably from 0.03 to 0.15 m, above the covering layer to be wetted.

It is possible to use a disk having from 2 to 4, preferably 2 or 3, particularly preferably 2, cascades.

Such an apparatus for applying the bonding agent c) is described, for example, in WO 2006/029786.

The process of the invention and the apparatus described are particularly suitable for systems comprising physical blowing agents, in particular pentanes. Furthermore, the process of the invention is especially suitable for producing composite elements having rigid covering layers.

As covering layer a), it is possible to use flexible or rigid, preferably rigid, covering layers such as plasterboards, fiberglass mats, aluminum foils, aluminum, copper or steel sheets, preferably aluminum foils, aluminum or steel sheets, particularly preferably steel sheets. The steel sheets can be coated or uncoated. The steel sheets can be pretreated, for example by corona, arc or plasma treatment or other customary methods.

The covering layer a) is preferably transported at a constant velocity of from 1 to 60 m/min, more preferably from 2 to 150 m/min, particularly preferably from 2.5 to 30 m/min and in particular from 2.5 to 20 m/min. The covering layer is in a horizontal position at least from the application of the foam system b), preferably during the entire time from the application of the bonding agent c).

When metal sheets and foils are used as covering layers in the process of the invention, the covering layers are, in succession, rolled off a roll, if appropriate profiled, heated, if appropriate pretreated in order to improve the ability to have polyurethane foam applied, the bonding agent is optionally applied, the starting material for the rigid foam based on isocyanate b) is applied by means of the casting bar arranged according to the invention, cured in the double belt and finally cut to the desired length.

The rigid foams based on isocyanate b) used for the process of the invention are produced in a customary and known manner by reaction of polyisocyanates with compounds having at least two hydrogen atoms which are reactive toward isocyanate groups in the presence of blowing agents, catalysts and customary auxiliaries and/or additives. As regards the starting materials used, the following details may be provided.

Possible organic polyisocyanates are all known organic diisocyanates and polyisocyanates, preferably aromatic polyfunctional isocyanates.

Specific examples are tolylene 2,4- and 2,6-diisocyanate (TDI) and the corresponding isomer mixtures, diphenylmethane 4,4′-, 2,4′- and 2,2′-diisocyanate (MDI) and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (crude MDI) and mixtures of crude MDI and tolylene diisocyanates. The organic diisocyanates and polyisocyanates can be used individually or in the form of mixtures.

Use is frequently also made of modified polyfunctional isocyanates, i.e. products which are obtained by chemical reaction of organic diisocyanates and/or polyisocyanates. Examples which may be mentioned are diisocyanates and/or polyisocyanates comprising uretdione, carbamate, isocyanurate, carbodiimide, allophanate and/or urethane groups. The modified polyisocyanates can, if appropriate, be mixed with one another or with modified organic polyisocyanates such as diphenylmethane 2,4′-, 4,4′-diisocyanate, crude MDI, tolylene 2,4- and/or 2,6-diisocyanate.

In addition, reaction products of polyfunctional isocyanates with polyfunctional polyols and also mixtures of these with other diisocyanates and polyisocyanates can also be used.

A particularly useful organic polyisocyanate has been found to be crude MDI, in particular crude MDI having an NCO content of from 29 to 33% by weight and a viscosity at 25° C. in the range from 150 to 1000 mPas.

As compounds having at least two hydrogen atoms which are reactive toward isocyanate groups, it is possible to use ones which have at least two reactive groups selected from among OH groups, SH groups, NH groups, NH₂ groups and acidic CH groups, preferably OH groups, and in particular polyether alcohols and/or polyester alcohols having OH numbers in the range from 25 to 800 mg KOH/g.

The polyester alcohols used are usually prepared by condensation of polyfunctional alcohols, preferably diols, having from 2 to 12 carbon atoms, preferably from 2 to 6 carbon atoms, with polyfunctional carboxylic acids having from 2 to 12 carbon atoms, for example succinic acid, glutaric acid, adipic acid, suberic acid, azelaic acid, sebacic acid, decanedicarboxylic acid, maleic acid, fumaric acid and preferably phthalic acid, isophthalic acid, terephthalic acid and the isomeric naphthalenedicarboxylic acids.

The polyesterols used usually have a functionality of 1.5-4.

Particular preference is given to using polyether polyols which have been prepared by known methods, for example by anionic polymerization of alkylene oxides onto H-functional starter substances in the presence of catalysts, preferably alkali metal hydroxides or double metal cyanide catalysts (DMC catalysts).

As alkylene oxides, use is usually made of ethylene oxide or propylene oxide or else tetrahydrofuran, various butylene oxides, styrene oxide, preferably pure 1,2-propylene oxide. The alkylene oxides can be used individually, alternately in succession or as mixtures.

Starter substances used are, in particular, compounds having at least 2, preferably from 2 to 8, hydroxyl groups or at least two primary amino groups in the molecule.

As starter substances having at least 2, preferably from 2 to 8, hydroxyl groups in the molecule, preference is given to using trimethylolpropane, glycerol, pentaerythritol, sugar compounds such as glucose, sorbitol, mannitol and sucrose, polyhydric phenols, resols such as oligomeric condensation products of phenol and formaldehyde and Mannich condensates of phenols, formaldehyde and dialkanolamines and also melamine.

As starter substances having at least two primary amino groups in the molecule, preference is given to using aromatic diamines and/or polyamines, preferably phenylenediamines, 2,3-, 2,4-, 3,4- and 2,6-toluenediamine and 4,4′-, 2,4′- and 2,2′-diaminodiphenylmethane, and also aliphatic diamines and polyamines such as ethylenediamine.

The polyether polyols have a functionality of preferably from 2 to 8 and hydroxyl numbers of preferably from 25 mg KOH/g to 800 mg KOH/g and in particular from 150 mg KOH/g to 570 mg KOH/g.

The compounds having at least two hydrogen atoms which are reactive toward isocyanate also include the chain extenders and crosslinkers which may be concomitantly used if appropriate. The addition of bifunctional chain extenders, trifunctional and higher-functional crosslinkers or, if appropriate, mixtures thereof can prove to be advantageous for modifying the mechanical properties. As chain extenders and/or crosslinkers, preference is given to using alkanolamines and in particular diols and/or triols having molecular weights of less than 400, preferably from 60 to 300.

Chain extenders, crosslinkers or mixtures thereof are advantageously used in an amount of from 1 to 20% by weight, preferably from 2 to 5% by weight, based on the polyol component.

The production of the rigid foams is usually carried out in the presence of blowing agents, catalysts, flame retardants and cell stabilizers and also, if necessary, further auxiliaries and/or additives.

As blowing agents, it is possible to use chemical blowing agents such as water and/or formic acid which react with isocyanate groups to eliminate carbon dioxide or carbon dioxide and carbon monoxide. Physical blowing agents can also preferably be used in combination with or preferably in place of water. These are compounds which are inert toward the starting components and are usually liquid at room temperature and vaporize under the conditions of the urethane reaction. The boiling point of these compounds is preferably below 50° C. Physical blowing agents also include compounds which are gaseous at room temperature and are introduced under pressure into the starting components or are dissolved therein, for example carbon dioxide, low-boiling alkanes and fluoroalkanes.

The blowing agents are usually selected from the group consisting of formic acid, alkanes and cycloalkanes having at least 4 carbon atoms, dialkyl ethers, esters, ketones, acetals, fluoroalkanes having from 1 to 8 carbon atoms and tetraalkylsilanes having from 1 to 3 carbon atoms in the alkyl chain, in particular tetramethylsilane.

Examples which may be mentioned are propane, n-butane, isobutane and cyclobutane, n-pentane, isopentane and cyclopentane, cyclohexane, dimethyl ether, methyl ethyl ether, methyl butyl ether, methyl formate, acetone and also fluoroalkanes which are degraded in the troposphere and therefore do not damage the ozone layer, e.g. trifluoromethane, difluoromethane, 1,1,1,3,3-pentafluorobutane, 1,1,1,3,3-pentafluoropropane, 1,1,1,2-tetrafluoroethane, difluoroethane and heptafluoropropane.

The physical blowing agents mentioned can be used either alone or in any combinations with one another.

A particularly preferred blowing agent mixture is a mixture of formic acid, water and pentane.

The blowing agent component is usually used in an amount of from 1 to 45% by weight, preferably from 1 to 30% by weight, particularly preferably from 1.5 to 20% by weight and in particular from 2 to 15% by weight, based on the total weight of the components polyol, blowing agent, catalyst system and possibly foam stabilizers, flame retardants and other additives.

The polyurethane or polyisocyanurate foams usually comprise flame retardants. Preference is given to using bromine-free flame retardants. Particular preference is given to phosphorus-comprising flame retardants, in particular trischloroisopropyl phosphate, diethyl ethanephosphonate, triethyl phosphate and/or diphenyl cresyl phosphate.

Catalysts used are, in particular, compounds which strongly accelerate the reaction of the isocyanate groups with the groups which are reactive toward isocyanate groups. Such catalysts are, for example, basic amines such as secondary aliphatic amines, imidazols, amidines, alkanolamines, Lewis acids or organic metal compounds, in particular those based on tin. Catalyst systems comprising a mixture of various catalysts can also be used.

If isocyanurate groups are to be incorporated into the rigid foam, specific catalysts are required. As isocyanurate catalysts, use is usually made of metal carboxylates, in particular potassium acetate, and solutions thereof. The catalysts can, depending on requirements, be used either alone or in any mixtures with one another.

Auxiliaries and/or additives used are the substances known per se for this purpose, for example surface-active substances, foam stabilizers, cell regulators, fillers, pigments, dyes, antioxidants, hydrolysis inhibitors, antistatics, fungistatic and bacteriostatic agents.

Further details regarding the starting materials, blowing agents, catalysts and auxiliaries and/or additives used for carrying out the process of the invention may be found, for example, in Kunststoffhandbuch, Volume 7, “Polyurethane” Carl-Hanser-Verlag Munich, 1st Edition, 1966, 2nd Edition, 1983 and 3rd Edition, 1993.

To produce the rigid foams based on isocyanate, the polyisocyanates and the compounds having at least two hydrogen atoms which are reactive toward isocyanate groups are reacted in such amounts that the isocyanate index in the case of polyurethane foams is in the range from 100 to 220, preferably from 115 to 180.

In the production of polyisocyanurate foams, it is also possible to carry out the reaction at an index of >180, in general from 180 to 700, preferably from 200 to 550, particularly preferably from 250 to 500 and in particular from 270 to 400.

The rigid polyurethane foams can be produced discontinuously or continuously with the aid of known mixing apparatuses. The mixing of the starting components can be effected with the aid of known mixing apparatuses.

The isocyanate-based rigid foams according to the invention are usually produced by the two-component process. In this process, the compounds having at least two hydrogen atoms which are reactive toward isocyanate groups are mixed with the blowing agents, the catalysts and the further auxiliaries and/or additives to form a polyol component and this is reacted with the polyisocyanates or mixtures of the polyisocyanates and, if appropriate, blowing agents, also referred to as isocyanate component.

The starting components are usually mixed at a temperature of from 15 to 35° C., preferably from 20 to 30° C. The reaction mixture can be mixed using high- or low-pressure metering machines.

The density of the rigid foams used is preferably from 10 to 400 kg/m³, preferably from 20 to 200 kg/m³, in particular from 30 to 100 kg/m³.

The thickness of the composite elements is usually in the range from 5 to 250 mm.

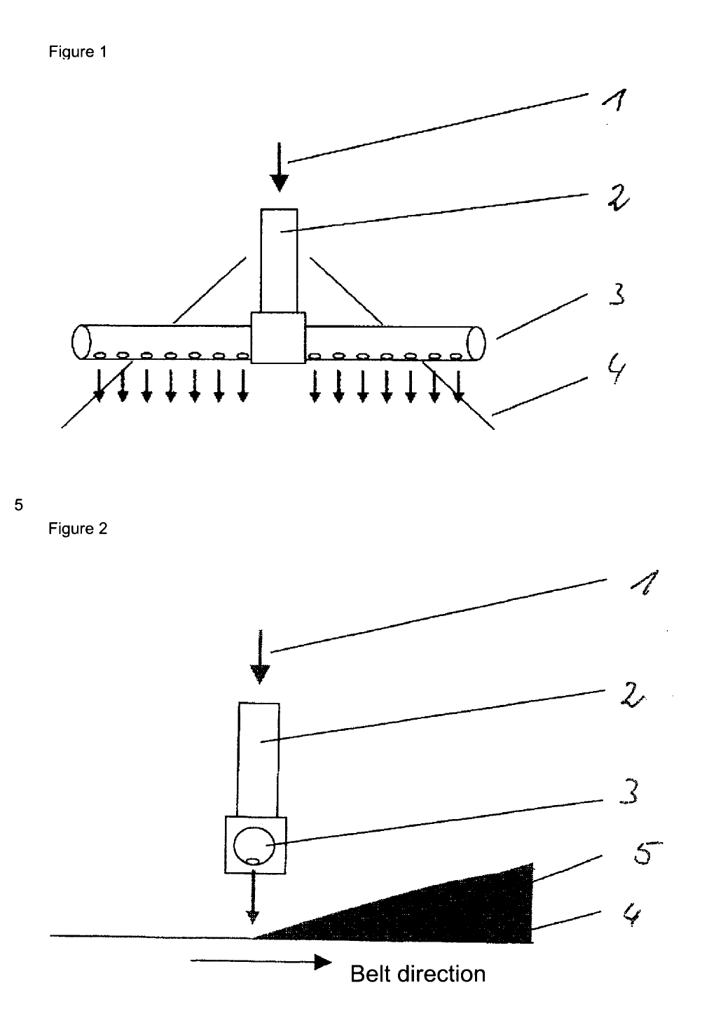

FIG. 1 shows the tube according to the invention for applying the rigid foams from the front and FIG. 2 shows it from the side. Here, 1 denotes the flow direction of the reaction mixture, 2 denotes the feed facility for the reaction mixture, 3 denotes the application tube with the orifices, 4 denotes the lower covering layer and 5 denotes the foam layer being formed on the lower covering layer.

The invention is illustrated by the following examples.

### EXAMPLES

### A) Composition of a PUR System

### Polyol Component (A Component)

44 parts of polyetherol 1 comprising propylene oxide and an amine starter, functionality=4, hydroxyl number=400 mg KOH/g
26 parts of polyetherol 2 comprising propylene oxide and sucrose as starter, OHN=400 mg KOH/g
5 parts of polyetherol 3 comprising propylene oxide and trimethylolpropane as starter, OHN=200 mg KOH/g
20 parts of flame retardant 1, viz. trischloroisopropyl phosphate, TCPP
2 parts of silicone-comprising stabilizer
2 parts of catalyst 1, viz. amine-comprising PUR catalyst
1 part of catalyst 2, viz. amine-comprising blowing catalyst
   Blowing agent 1 n-pentane
   Blowing agent 2 water
   Blowing agent 3 aqueous formic acid, 85% strength

### Isocyanate Component (B Component)

Isocyanate Lupranat M50, polymeric MDI (BASF AG), NCO content=31%, viscosity=500 mPas at 25° C.

A component, B component and blowing agents were reacted in such ratios that the index was in the region of 130 and a foam density of 39 g/l was achieved.

### B) Composition of a PIR System

### Polyol Component (A Component)

66 parts of polyesterol 1 comprising phthalic anhydride, diethylene glycol and oleic acid, functionality=1.8, hydroxyl number=200 mg KOH/g
30 parts of flame retardant 1, viz. trischloroisopropyl phosphate, TCPP
1.5 parts of stabilizer 1, viz. silicone-comprising stabilizer
1.5 parts of catalyst 1, viz. PIR catalyst, salt of a carboxylic acid
1 part of catalyst 2, viz. amine-comprising PUR catalyst
   Blowing agent 1 n-pentane
   Blowing agent 2 water
   Blowing agent 3 aqueous formic acid, 85% strength
   Isocyanate component (B component)

Isocyanate Lupranat M50, polymeric MDI (BASF AG), NCO content=31%, viscosity=500 mPas at 25° C.

A component, B component and blowing agent were mixed with one another in such ratios that the index was in the region of 350 and a foam density of 43 g/l was achieved.

The polyurethane and polyisocyanurate systems b) were applied in succession by means of an oscillating casting bar and a fixed casting bar.

The oscillating casting bar had the dimensions 25 cm×1.5 cm, had 41 holes having a diameter of 1.6 mm and a hole spacing of 5 mm and oscillated at a velocity of 2.8 m/s over a distance of 1.0 m.

The fixed casting bar had the dimensions 100 cm×1.5 cm, had 90 holes having a diameter of 1.6 mm and a hole spacing of 11 mm.

The application rate was 16.1 kg/min for each of the two casting bar systems.

The metallic covering layer was not corona treated. The double belt had a width of 1.2 m and was moved forward at a constant velocity of 5.5 m/min. The temperature of the metal sheet was 37° C. and that of the double belt was set to 40° C. (PUR) or 60° C. (PIR). The sandwich element thickness was 60 mm.

After curing of the system, test specimens having dimensions of 100×100×5 mm were sawn out and the adhesion of the foam to the covering layer was determined in accordance with DIN EN ISO 527-1/DIN 53292.

The frequency of surface defects was determined quantitatively by an optical method. For this purpose, material above a plane through a foam specimen was cut off at a distance of one millimeter from the lower covering layer, i.e. the covering layer onto which the polyurethane reaction solution was applied in the double belt process. The foam surface obtained in this way was illuminated at an included angle of 5° and the area of the shadow thrown by surface defects was divided by the total surface area. For this purpose, the illuminated foam surface was photographed and the foam images were subsequently binarized. The integrated area of the black regions of the binary images was divided by the total area of the images and thus represents a measure of the frequency of surface defects. Furthermore, an additional qualitative assessment of the nature of the surface of the foams was carried out by removing the covering layer from a 1 m×2 m foam specimen and visually assessing the surface.

The various experiments using different rigid foam systems and an oscillating and fixed casting bar are compared in Table 1.

TABLE 1
Experimental parameters and results. The uniformity of the applied layer over
the surface of the covering layer is assessed.

| | | | | | | Appearance | Number |
|---|---|---|---|---|---|---|---|
| | | Casting | Compressive | Tensile | | of | of voids/ |
| Experiment | Foam | bar | strength | strength | Adhesion | applied | surface |
| No. | system | system | [N/mm²] | [N/mm²] | [N/mm²] | foam | defects |
| 1 (C) | PUR | oscillating | 0.114 | 0.14 | | Furrow | 12% |
| | | | | | | pattern | |
| 2 | PUR | fixed | 0.117 | 0.16 | | Flat and | 2% |
| | | | | | | pattern- | |
| | | | | | | free | |
| 3 (C) | PIR | oscillating | | | | Furrow | 10% |
| | | | | | | pattern | |
| 4 | PIR | fixed | | | | Flat and | 1% |
| | | | | | | pattern- | |
| | | | | | | free | |

C—Comparative example

The results in Table 1 show that the frequency of the formation of surface defects at the interface to the metallic covering layers is significantly reduced by the use of the fixed casting bar according to the invention compared to the prior art and the mechanical properties of the foam and also the adhesion between rigid foam and covering layer are improved.

1. A process for producing composite bodies comprising at least one covering layer a) and a rigid foam based on isocyanate b), in which the covering layer a) is moved continuously and the starting material for the rigid foam based on isocyanate b) is applied to the covering layer, wherein the application of the liquid starting material for the rigid foam based on isocyanate b) is effected by means of a fixed tube which is provided with orifices and is arranged parallel to the covering layer a) and at right angles to the direction of movement of the covering layer a).

2. The process according to claim 1, wherein the width of the tube provided with orifices corresponds to at least 70% of the width of the covering layer a), with the tube provided with orifices being arranged so that an equally wide region at each of the margins of the covering layer is not covered by the tube.

3. The process according to claim 1, wherein the tube provided with orifices is located at a height of from 10 to 30 cm above the covering layer a).

4. The process according to claim 1, wherein the diameter of the tube is from 0.2 to 5 cm.

5. The process according to claim 1, wherein the diameter of the tube provided with orifices decreases from the middle to the ends of the tube.

6. The process according to claim 1, wherein the liquid starting material for the rigid foam based on isocyanate b) is fed in at the middle of the tube provided with orifices.

7. The process according to claim 1, wherein the diameter of the orifices is from 0.5 to 5 mm.

8. The process according to claim 1, wherein the distances of the orifices from one another is from 5 to 60 mm.

9. The process according to claim 1, wherein the diameter of the orifices decreases from the middle to the ends.

10. The process according to claim 1, wherein the spacing of the orifices decreases from the middle to the ends.

11. The process according to claim 1, wherein the rigid foam based on isocyanate b) comprises isocyanurate groups.

12. The process according to claim 1, wherein a bonding agent c) is applied to the covering layer a) before application of the starting material for the rigid foam based on isocyanate b).

13. The process according to claim 1, wherein a reactive single-component or multi-component polyurethane system is used as bonding agent c).

14. The process according to claim 1, wherein the bonding agent c) is applied to the covering layer by means of a rotating disk which is located before the tube provided with orifices in the direction of movement of the covering layer a).

15. An apparatus for applying reaction mixtures to a continuously transported covering layer, wherein the apparatus is a fixed tube which is provided with orifices and is arranged parallel to the covering layer a) and at right angles to the direction of movement of the covering layer a).
